(19) United States
(12) Patent Application Publication
(10) Pub. No.: US 2016/0053737 A1
(43) Pub. Date: Feb. 25, 2016

(54) PLC CONTROLLED SUPPLEMENTAL STARTING SYSTEM

(71) Applicant: Kold Ban International, Ltd., Lake In The Hills, IL (US)

(72) Inventors: Dean Solberg, Burlington, WI (US); James Burke, Richmond, IL (US)

(21) Appl. No.: 14/829,371

(22) Filed: Aug. 18, 2015

Related U.S. Application Data
(60) Provisional application No. 62/040,168, filed on Aug. 21, 2014.

(51) Int. Cl. F02N 11/08; H02J 7/00

(52) U.S. Cl. CPC F02N 11/0866; H02J 7/0029; H02J 7/0052; H02J 7/007; H02J 7/345

(57) ABSTRACT

A vehicle power starting method generates a recharging function based on a temperature and a voltage of a vehicle starting capacitor. The method determines a temperature of the vehicle starting capacitor when the capacitor is running in parallel with the motorized vehicle's battery and the motorized vehicle's electrical system. The method calculates a maximum charging level of the vehicle starting capacitor when running in parallel with a motorized vehicle's battery and the motorized vehicle's electrical system; and adapts the recharging process of the vehicle starting capacitor based on the recharging function and a predetermined charging timed cycle.

### PRIORITY CLAIM

This application claims the benefit of priority from U.S. Provisional Application No. 62/040,168 filed Aug. 21, 2014, under attorney docket number 70-99, entitled “PLC Controlled Supplemental Starting System” which is incorporated herein by reference.

### TECHNICAL FIELD

This disclosure relates to charging systems, and particularly to a programmable logic controlled starting system.

### RELATED ART

A starter that fails to crank an engine or cranks the engine too slowly may be caused by a low charged battery. The proliferation of accessories or failing components in a vehicle can place a significant load on a battery to the point that the battery will not start an engine when it is needed.

While systems have been developed to recharge batteries, many fail to monitor the vehicle's charging system. Some systems fail to communicate with the vehicle or perform diagnostics. Other systems fail to monitor the recharging sources when not delivering power to the vehicle.

### BRIEF DESCRIPTION OF THE DRAWINGS

FIG. 1 is a vehicle electrical system.

FIG. 2 is the vehicle electrical system of FIG. 1, with a multi-pole switch (e.g., a triple poll switch) in a start position and a switch in a closed-circuit condition.

FIG. 3 is the vehicle electrical system of FIG. 1, with the multi-pole switch in the on/run position and the switch in a closed-circuit condition.

FIG. 4 is a vehicle electrical system, with a multi-pole switch (e.g., a two pole switch) in an off position and the switch in an open-circuit condition.

FIG. 5 is the vehicle electrical system of FIG. 4, with the multi-pole switch in a to start position and the switch in a closed-circuit condition.

FIG. 6 is the vehicle electrical system of FIG. 4, with the multi-pole switch in the on/run position and the switch in a closed-circuit condition.

FIG. 7 illustrates the functionality of a programmable logic controller or microprocessor based charge controller.

FIG. 8 is a graph illustrating one implementation of a maximum charging function.

FIG. 9 illustrates a temperature monitoring system interfaced to the programmable logic controller or microprocessor based charge controller of FIG. 7.

FIG. 10 is a graph illustrating one implementation of a temperature estimating function.

FIG. 11 a programmable logic controller or microprocessor based charge controller of the vehicle starting system.

### DETAILED DESCRIPTION OF THE PREFERRED EMBODIMENTS

To protect vehicles and charging systems during charging events, the disclosed vehicle starting systems and methods monitor and control the charging process in real time. The systems and methods use a microprocessor based controller that accesses programmable memory to store information, execute program modules, control interface sequencing, timing and code sequencing, and enable communication with other electronic systems including the vehicle's powertrain systems, engine control units, and vehicle sensors used to control the powertrain of the vehicle. The system's (and method's) memory include read only memory that retains the instructions that monitor and control the charging system; a separate random access scratch pad memory that stores the output of the device (and method) and in some systems output from the in-vehicle sensors and diagnostic codes for the system and method, such as when a malfunction or transient state is detected, and a programmable read only memory that stores the calibration data for the charging system. The system and methods can self-diagnose themselves as well as other system components in the vehicle such as a generator, alternator, the battery, etc.

Unlike conventional computers that are designed for calculation and displaying executed tasks in controlled environments, the microprocessor based controllers in this disclosure are optimized for use in severe environmental conditions such as in high and low temperatures, excessive engine vibrations, high humidity, and electrical noise. The microprocessor based control technology includes two, three, or more external interfaces that provide input and output data functionality that allows the controller to gather data from many external systems including systems that communicate via data links found under the vehicle's hood and in the vehicle's cabin. Some microprocessor based controllers automatically detect and communicate (e.g., transmit and receive) data from an in-vehicle controller, such as an engine control unit, or an electronic control module, for example. The systems may automatically detect and communicate in SAE J1939 and ISO 11783 protocol (also called “ISO Bus” or “ISOBUS”), which is an adaptation of CAN for commercial (J1939) and agricultural (ISO 11783) vehicles by executing a computer handshaking protocol. Computer handshaking is an automated process of negotiation that dynamically detects the communication protocol and sets parameters of a communications channel established between two entities before normal communication over the channel begins. It follows the physical or virtual establishment of the channel and precedes normal information transfer. Some systems automatically detect, access, retrieve and communicate through one, more (e.g., any subset of other) vehicle protocols through a computer handshaking protocol, including Byteflight (an automotive a message oriented protocol), Controller Area Network bus or CAN bus (another message-base protocol), Domestic Digital Bus, D2B (an isochronous ring-based fiber optical communication protocol), FlexRay (an automotive network communications protocol). IEbus, I²C or Inter-Integrated Circuit (a multi-master, multi-slave, single-ended, serial computer bus), ISO-9141-1/-11, J1708 and J1587, J1850, Keyword Protocol 2000 or KWP2000 (a protocol for automotive diagnostic devices (runs either on a serial line or over CAN), LIN or Local Interconnect Network a very low cost in-vehicle sub-network, MOST or Media Oriented Systems Transport (a high-speed multimedia interface, Multifunction Vehicle Bus (part of the Train Communication Network IEC 61375), SMARTwireX, SPI (communicate in master slave mode), VAN or Vehicle Area Network, etc.

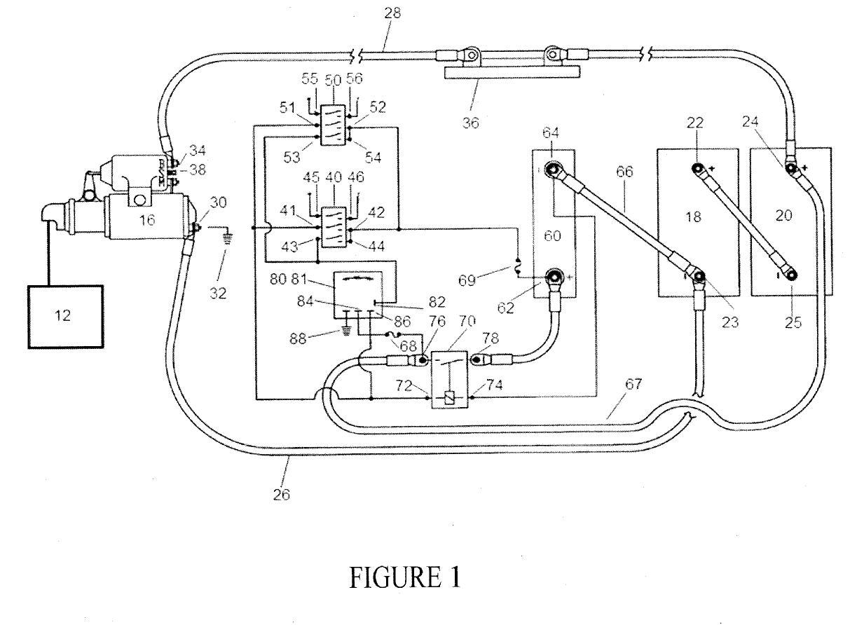

FIGS. 1-3 show electrical systems that may couple or interface an engine 12, which may comprise a diesel or gasoline engine. The engine 12 mechanically couples a cranking motor 16 that may be energized during a cranking event powered by an external source such as through one or more storage batteries 18, 20 such as lead-acid batteries. The batteries 18, 20, which may be protected within an enclosure (not shown), may be removably coupled to other components of the vehicle's electrical system. Battery 18 incudes a positive terminal 22 and negative terminal 23, and battery 20 includes a positive terminal 24 and negative terminal 25. Because the batteries are connected in series positive terminal 22 is electrically coupled to negative terminal 25 with negative terminal 23 electrically coupled to the cranking motor 16 at terminal 30 through an electrical path 26. The terminal 30 is electrically coupled to system ground 32. The positive terminal 24 is electrically coupled to a B terminal 34 of the cranking motor 16 via an electrical path 28 and a master disconnect switch 36 which is operable between a closed position (shown in FIGS. 1-3) which closes the electrical path 28 and an open position (not shown) which opens the electrical path 28. Current from the batteries 18, 20 flows to the cranking motor 16 through a switch such as a solenoid switch 38. Elements 12 through 38 are electrically connected and interfaced in other configurations in alternative systems.

In operation, solenoid switch 38 is activated when the multi-pole switch 40 is in a start position. The multi-pole switch 40 may be a triple pole, single throw (TPST) start switch comprised of a first switch having switched terminals 41, 42, a second switch having switched terminals 43, 44, and a third switch having switched terminals 45, 46. Terminals 45, 46 interface the vehicle's OEM starting circuit (not shown) for ignition when multi-pole switch 40 fails to provide a set of separate and independent contacts. In other systems, switches having other positions are used. Further, in some systems, an off/run switch is positioned between at least an off position and run position, and a separate push-button, crank switch that is actuated to crank the starter motor. In these systems, one or both of the off/run switch with or separate from a separate push-button switch comprise the multi-pole switch, with the multi-pole switches being in the “start” position when the off/run switch is in the “on” or “run” position and the crank switch is in the engaged state. The electrical system may also include a second or rear multi-pole switch 50 that is identical or nearly identical to the multi-pole switch 40 except that it is located in a separate or rear location rather than the front of the vehicle. The rear multi-pole switch 50 is comprised of a first switch having switched terminals 51, 52, a second switch having switched terminals 53, 54, and a third switch having switched terminals 55, 56. The switched terminals 42, 52 are respectively electrically coupled to the switched terminals 44, 54 via electrical paths.

In addition to the electrical system, the vehicle also includes a supplemental electrical system including a capacitor 60 and a control circuit. The supplemental electrical system, which may be housed in an enclosure (not shown), may be removably coupled to the vehicle's electrical system. The capacitor 60 is preferably a double layer capacitor or an electrochemical capacitor. In some systems, the capacitor 60 has a capacitance of 500 farads, a stored energy capacity of 120 kilojoules, an internal resistance at 25 degrees Celsius of 0.006 ohms, and a maximum storage capacity of 35 kilowatts. In other systems the capacitor has a capacitance greater than about 149 farads, and an internal resistance at about 25 degrees Celsius that is preferably less than about 0.008 ohms internal resistance, and more preferably less than about 0.006 ohms, and most preferably less than about 0.003 ohms. The energy storage capacity is preferably greater than 15 kJ. Such capacitors provide the advantage of delivering high currents at low temperatures and relatively low voltages because of their low internal resistance. Though not shown, the electrical system of the vehicle may include a generator or alternator driven by the engine when running to charge both the batteries 18, 20 and capacitor 60. In systems lacking the batteries 18, 20, the generator or alternator, or another feature of the electrical system, charges the capacitor 60.

The capacitor 60 includes a positive terminal 62 and a negative terminal 64. The negative terminal 64 is electrically coupled to the negative terminal 23 of battery 18 through electrical path 66. The positive terminal 62 is electrically coupled to the positive terminal 24 of battery 20 via the electrical path 67 via a cable and a relay 70. In systems lacking the batteries 18, 20, the terminals 22, 23, 24, 25 are also absent, and thus the electrical paths 26 and 66 may form an electrical path, and electrical path 28 and electrical path 67 may form a single direct electrical path.

The relay 70 includes first and second control terminals 72, 74 and first and second switched terminals 76, 78. The first control terminal 72 is electrically coupled to each of the switched terminals 41, 51 of the multi-pole switches 40, 50 via intersecting electrical paths. The second control terminal 74 is electrically coupled to the negative terminal 64 of the capacitor 60 via an electrical path. The switched terminals 76, 78 are included in the electrical path 67 such that the relay 70 interrupts the electrical path 67 when the relay is in an open-circuit condition. The relay 70 completes the electrical path 67 when the relay is in a closed-circuit condition. The relay 70 may take many forms, and may be a contactor relay. For example, a 24 volt contactor relay can be used such as that supplied by Tyco Electronics as part number LEV200A5ANF The switched terminals 42, 52 of the multi-pole switches 40, 50 are each electrically coupled to the positive terminal 62 of the capacitor 60 via intersecting electrical paths that include suitable cables and a five amp fuse 69.

The control circuit shown in FIGS. 1-3 and 11 comprises a programmable logic controller or microprocessor based charge controller (MCC) 80. In FIGS. 1-3 MCC 80 is coupled to a start, power, and load switched terminals 82, 84, 86 and a system ground 88. The start switched terminal 82 (or control terminal) of MCC 80 is electrically coupled to the switched terminals 43, 53 of the respective multi-pole switches 40, 50 via electrical paths. The power switched terminal 84 of MCC 80 is electrically coupled to the first switched terminal 76 of the relay 70 via an electrical path that includes a five amp fuse 68. The load switched terminal 86 of MCC 80 is electrically coupled to the first control terminal 72 of the relay 70 via an electrical path. MCC 80 is operable to switch between an idle state, start-up state, and charging state.

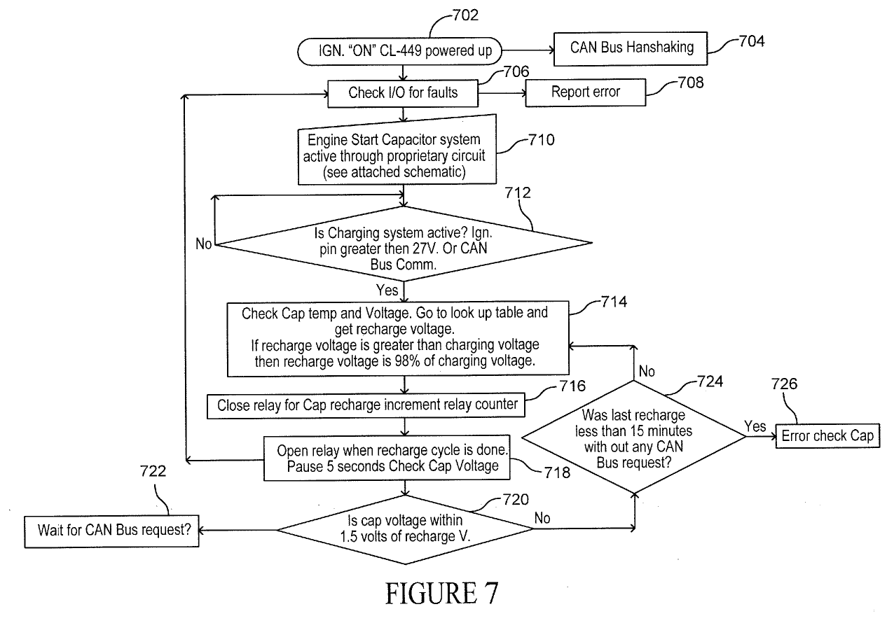

FIG. 7 illustrates the functionality of MCC 80. At ignition on, MCC 80 automatically detects, identifies, and negotiates with the communication protocol used in the vehicle at steps 702 and 704. In these steps, MCC 80 (which are executed with all of the other disclosed steps or some of the disclosed steps through program modules by the disclosed system) identifies the communication protocol used on the in-vehicle bus, dynamically sets the parameters of communication between the vehicle and MCC 80 before normal communication begins. It follows the wireless, physical, or combined medium establishment of the channel that couples MCC 80 to the vehicle bus but precedes the normal information transfer that occurs between them. In FIG. 7 a CAN bus handshaking is shown between the vehicle and the charge processing method.

The MCC 80 may begin its charge processing sequence in FIG. 7 by monitoring the condition of the charging system and the state of the I/O (Input/Out) ports at step 706. The system may monitor the condition of the capacitors, the switches (e.g., relays), operating temperatures, etc., and report any failures or faults through the vehicle bus or an external port at step 708. If MCC 80 detects a malfunction, it will generate a malfunction or diagnostic code, store the code in memory, and report the error at step 708. In some systems the report may be deliver by flashing a colored light (such as a red LED) at a predetermined frequency, such as at 1 Hz, for example. In some alternative systems, the detection of a malfunction will turn on or intermittently actuate a check system light in the vehicle charging system (and/or check engine light in the vehicle) and in other alternatives the MCC 80 will keep that light on as long as the malfunction exists. If the malfunction happens to correct itself, MCC 80 turns off the check system light (and/or check engine light in the vehicle), but retains the diagnostic code for the malfunction in its accessible memory.

To read the malfunction or diagnostic codes, the MCC 80 may enter a diagnostic mode in some systems. In this mode, MCC 80 may deliver the codes to the vehicle bus, such as a CAN bus allowing the code to be read through a diagnostic scanning device or through the vehicle's cluster. As codes are being read no new codes are stored to eliminate any confusion during the diagnostic mode. In addition, the codes may be delivered through an interface module coupled to one of the three interfaces through a graphical user interface or a Multi-color RGB LED tangibly or wirelessly coupled to an MCC 80 interface. Here, an interface comprises a point of interaction or communication between MCC 80 and another entity such as an external server.

On engine start, MCC 80 monitors the vehicle voltage to detect when the charging system comes on-line at steps 710 and 712. Monitoring continues until the charging system comes on-line. At step 712 MCC 80 may identify when the charging system comes on-line by monitoring the vehicle voltage or by querying the vehicle's powertrain controller (not shown) through the vehicle bus. In one implementation, the MCC 80 determines the vehicle's charging system is operational when the vehicle voltage exceeds a predetermined voltage. For example, MCC 80 may determine that the charging system is operational when the vehicle voltage exceeds about 27 V, or when the vehicle voltage falls below a predetermined threshold voltage and then exceeds a threshold with the multi-pole switch in the on state or the output of one or more vehicle sensors indicating that the engine is running. In one implementation, MCC 80 monitors the vehicle voltage through a voltage divider and regulating component (e.g., a diode). In another implementation the voltage is monitored through the vehicle bus and powertrain controller or engine control unit by querying the powertrain controller, electronic control module and/or in vehicle sensors.

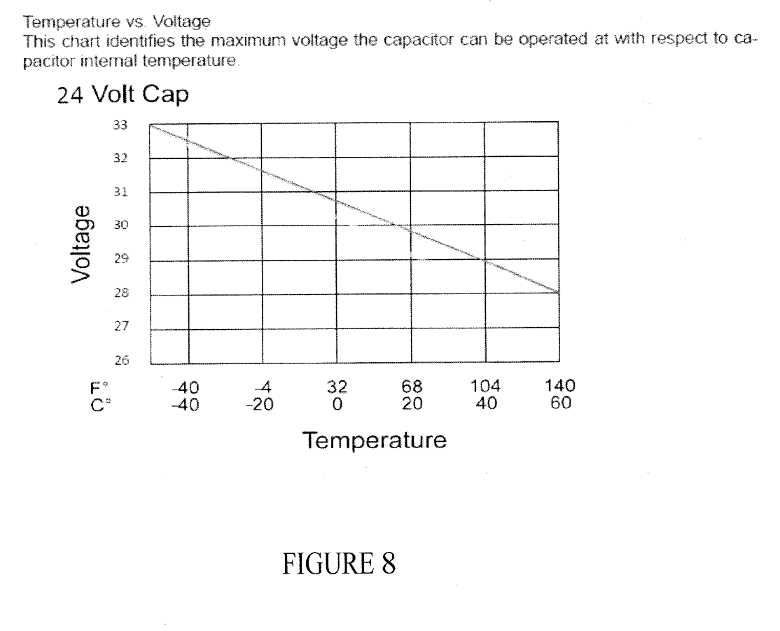

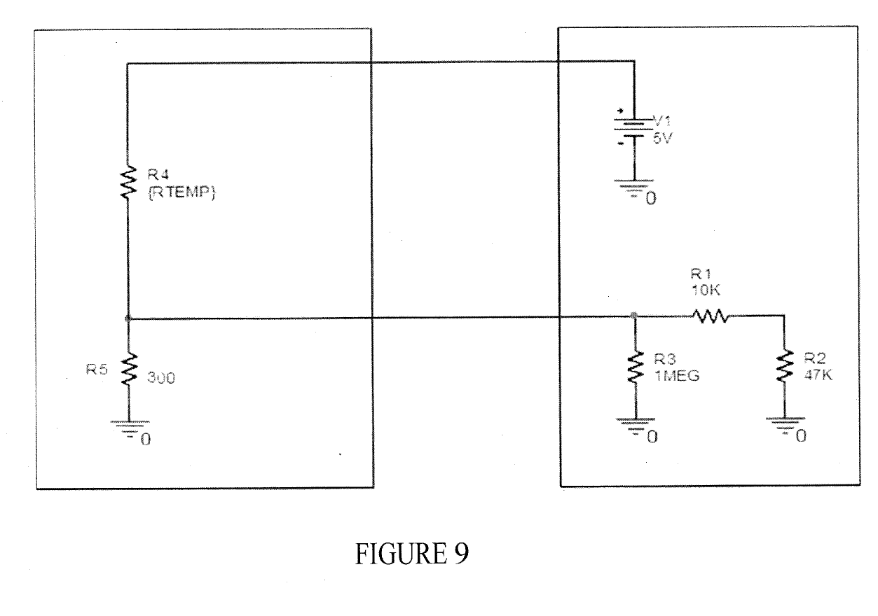

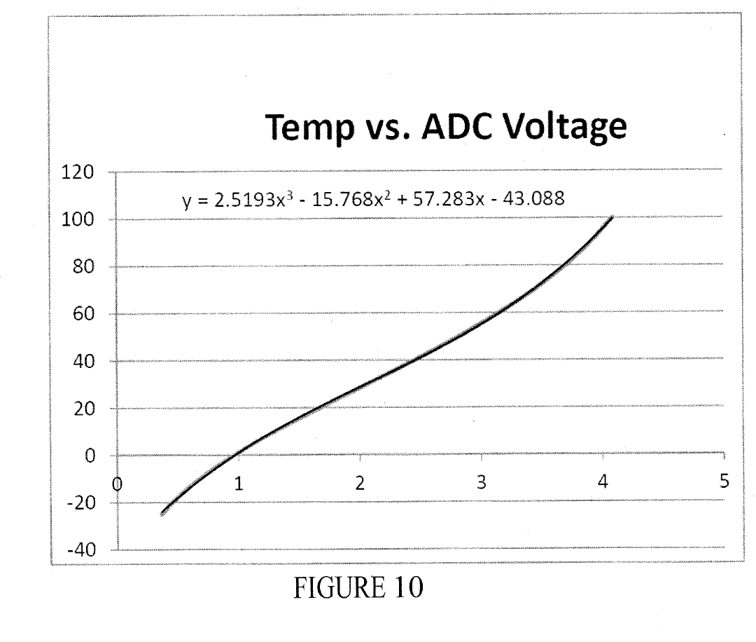

At step 712, MCC 80 transitions to the charging state when the vehicle's charging system is operational. At 714, MCC 80 monitors capacitor 60's temperature and voltage as system transitions from a start-up state to a capacitor charging state. FIG. 8 illustrates one implementation of a voltage versus temperature function. In the example of FIG. 8, MCC 80 determines a maximum charge voltage of capacitor 60 based on the temperature is of the capacitor 60. The maximum recharging voltage at step 714 weighs the influence of temperature on capacitor 60 to calculate its maximum recharge voltage. In one implementation, the temperature of capacitor 60 is estimated through a surrogate measurement by measuring the ambient temperature in proximity to capacitor 60. In FIG. 9, a monitored five volt supply biasing thermistor R4, through a pull-down resistor R5 measures a one-hundred and five degree resolution temperature range (e.g., between a negative 15 degrees C. to a positive 90 degree C.) that represents the temperature of the capacitor. In this implementation the analog to digital conversion (ADC) of the output of voltage divider R4 and R5 is cross-referenced to the function of temperature and ADC voltage shown in FIG. 10 to estimate the temperature of capacitor 60. At step 714 of FIG. 7, MCC 80 processes the temperature measurement and the voltage and temperature function shown on FIG. 8 to calculate the maximum recharge voltage of capacitor 60. As shown, when the temperature is low, the maximum recharging voltage is high. In this example, the voltage to temperature function has a substantially linear relationship.

At step 716, MCC 80 recharges capacitor 60 by coupling the vehicle voltage to capacitor 60 until the capacitor attains about 98% of its maximum recharge voltage or a charging cycle lapses. The charging state (or mode) may be maintained for a predetermined period of time measured a counter tracked by MCC 80. In alternative systems the time is tracked internally by MCC 80 and in some implementations the length of the charging state (or mode) may be dynamically set according to the current voltage state of capacitor 60 and the vehicle's operating voltage monitored by MCC 80.

Once the charging state (or mode) is completed, MCC 80 uncouples capacitor 60 from the vehicle's voltage (and electrical system) for a predetermined time (e.g., about 5 seconds) before measuring the capacitor's voltage at step 718. In FIG. 7, if the capacitive voltage is within a predetermined range, the system transitions into an idle state at step 720 until a request is received from the vehicle bus at step 722. If the capacitive voltage falls outside of the predetermined range during a predetermined timed interval, MCC 80 generates a malfunction or diagnostic code, stores the code in memory, and report the error at steps 724 and 726. As explained, in alternative systems the detection of a malfunction will flash a system output at a predetermined frequency or turn on a check system light (and/or check engine light in the vehicle) and will keep or flash that light on as long as the malfunction exists. If the malfunction happens to correct itself, MCC 80 turns off the check system light (and/or check engine light in the vehicle), but retains the code for the malfunction in memory. At 724 the MCC 80 performs the charging process described in steps 714-726 if the recharging of capacitor 60 occurred in less than a predetermined time.

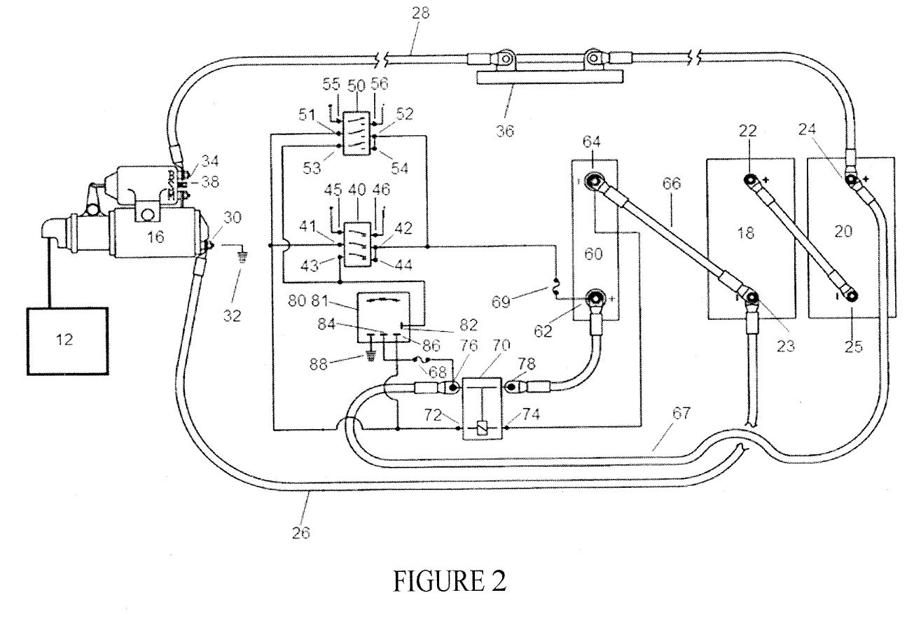

FIGS. 1-3 shows the operation of the electrical system of the vehicle. FIG. 1 shows the multi-pole switches 40, 50 each in their respective off positions, and the relay 70 in an open-circuit state, with MCC 80 in an idle state. FIG. 2 shows the multi-pole switch 40 switched into the start position which causes the capacitor 60 to apply a voltage between the control terminals 72, 74, thus closing the relay 70 and completing the electrical path 67. Thus the capacitor 60 and the batteries 18, 20 are connected in parallel to the cranking motor 16. The batteries 18, 20, and the capacitor 60 power the cranking motor 16 during ignition. If the batteries 18, 20 are discharged or not used, the capacitor 60 is operable to source power to the cranking motor 16 during ignition. Thus, in systems lacking batteries, the capacitor 60 may source the cranking motor 16 exclusively. The capacitor 60 also applies a voltage between the start switched terminal 82 and the power and/or load switched terminals 84, 86, thus providing power to MCC 80 during start-up. In other systems (not shown), a secondary capacitor, battery, or other power source, rather than the capacitor 60, sources the voltage between the start switched terminal 82 and the power and/or load switched terminals 84, 86. In some systems, the multi-pole switch 50 is also used in place of multi-pole switch 40.

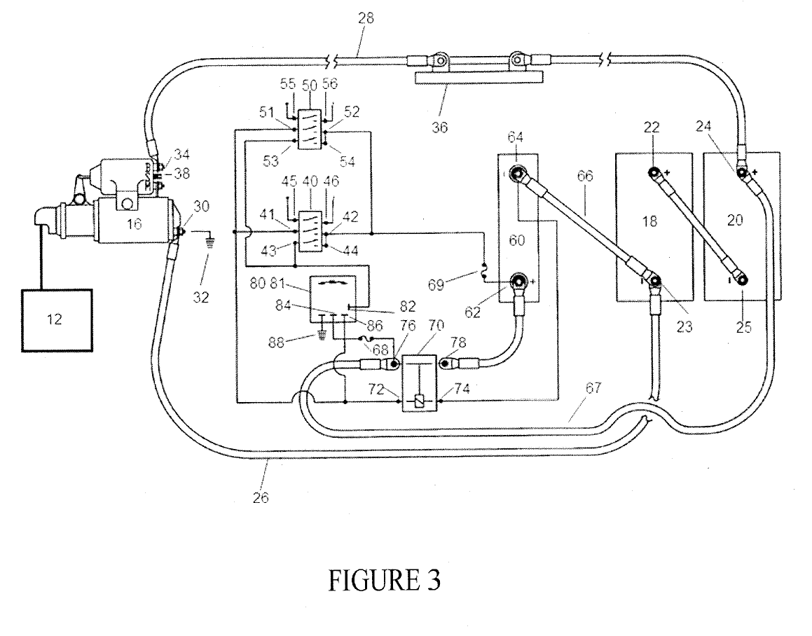

FIG. 3 shows the multi-pole switch 40 switched in the on/run position, which opens the electrical paths between switched terminals 41 and 42 and between switched terminals 43 and 44. Thus the capacitor 60 no longer delivers a voltage between the start switched terminal 82 and the power and/or load switched terminals 84, 86, causing MCC 80 to exit the start-up state and enter a charge state.

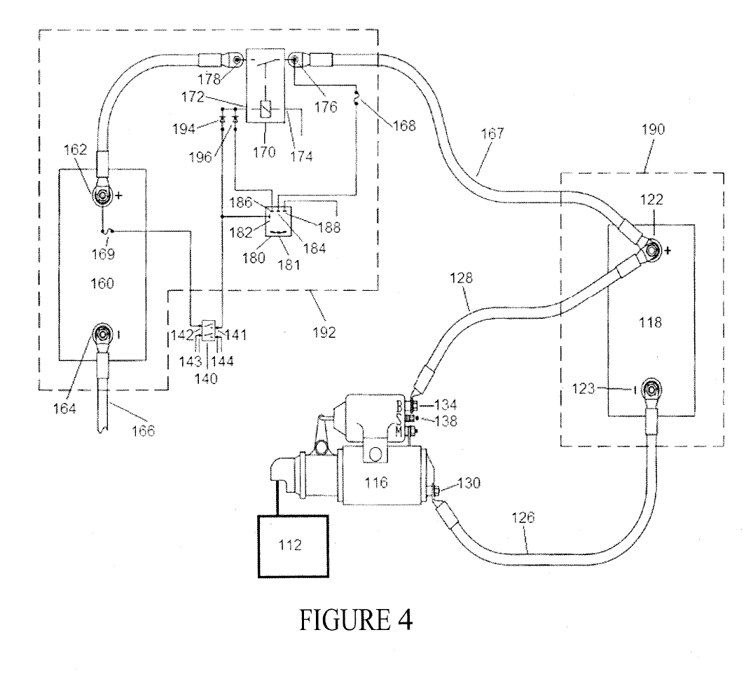

FIGS. 4-6 show various systems of the electrical system of a vehicle that includes an internal combustion engine 112. The engine 112 mechanically couples a cranking motor 116 that is powered during cranking conditions by current from one or more storage batteries 118. The batteries 118, which are enclosed by an enclosure 190, are removably coupled to other components in the electrical system. Negative terminal 123 of battery is electrically coupled to cranking motor 116 at terminal 130 via an electrical path 126. Positive terminal 122 is electrically coupled to a B terminal 134 of the cranking motor 116 via an electrical path 128. In some implementations, the electrical path 128 may also include a master disconnect switch that is operable between a closed position which closes the electrical path 128 and an open position which opens the electrical path 128. Current from the batteries 118 is switched to the cranking motor 116 via a switch such as solenoid switch 138.

Solenoid switch 138 is activated for example when an multi-pole switch 140, located in the front of the vehicle, is moved to a start position. The multi-pole switch 140 comprises a double pole, single throw (DPST) start switch. The multi-pole switch 140 comprises a first switch having switched terminals 141, 142, and a second switch having switched terminals 143, 144. In operation, the engine is operably transitions between a running state and an off state. The terminals 143, 144 interface the vehicle's existing starting circuit (not shown) if the multi-pole switch 140 cannot provide a set of separate and independent contacts. In some implementations, a switch is positioned between an off and run state, and a separate push-button, crank switch actuates the cranking or starting of the vehicle's motor. In these implementations one or both of the off/run switch and the mechanically separate push-button switch comprise the multi-pole switch, with the combined multi-pole switch being in the “start” position when the on/off switch is in the “on” position and the crank switch is engaged. Like the systems shown in FIGS. 1-3, the electrical system of FIGS. 4-6 may include a rear multi-pole switch (not shown) which is identical to the multi-pole switch 140 except that it is located in the rear rather than the front of the vehicle. The rear multi-pole switch may be a DPST start switch comprised of a first switch having two switched terminals and a second switch having two switched terminals.

In addition to the electrical system described, a vehicle may also include a supplemental electrical system including a capacitor 160 and a control circuit. The supplemental electrical system, which can be housed in an enclosure 192, can be coupled or removably coupled to the vehicle's electrical system. The capacitor 160 may be similar to capacitor 60. Though not shown in the figures, the electrical system of the vehicle includes a generator or alternator driven by the engine when running to charge the batteries 118 and capacitor 160. In systems lacking the batteries 118, the generator or alternator, or another feature of the electrical system, charges only the capacitor 160.

The capacitor 160 includes a positive terminal 162 and a negative terminal 164. The negative terminal 164 is electrically coupled to a ground via electrical path 166. The positive terminal 162 is electrically coupled to the positive terminal 122 of battery 118 via the electrical path 167 that includes a relay 170. In implementations lacking batteries 118, the terminals 122, 123 and the electrical path 126 are not used. Thus the electrical path 128 and electrical path 167 may form a single direct electrical path.

The relay 170 includes first and second control terminals 172, 174 and first and second switched terminals 176, 178. The first control terminal 172 is electrically coupled to the switched terminal 141 of the multi-pole switch 140 via an electrical path that includes a diode 194. The second control terminal 174 is electrically coupled to a ground. The switched terminals 176, 178 are included in the electrical path 167 such that the relay 170 interrupts the electrical path 167 when the relay is in an open-state. The relay 170 completes the electrical path 167 when the relay is in a closed-state. The switched terminal 142 of the multi-pole switch 140 is electrically coupled to the positive terminal 162 of the capacitor 160 via a fused electrical path.

The control circuit includes a programmable logic controller or microprocessor based charge controller (MCC) 180 coupled to a start, power, and load switched terminals 182, 184, 186 and a system ground 188. MCC 180, which is similar, and in some implementations, identical to MCC 80 is electrically coupled to the switched terminal 141 of the multi-pole switch 140 via an electrical path. A power switched terminal 184 of MCC 180 electrically couples the first switched terminal 176 of the relay 170 via a fused 168 electrical path. The load switched terminal 186 of MCC 180 is electrically coupled to the first control terminal 172 of the relay 170 via an electrical path that includes diode 196. MCC 180 is operable to switch between an idle state, start-up state, and charging state.

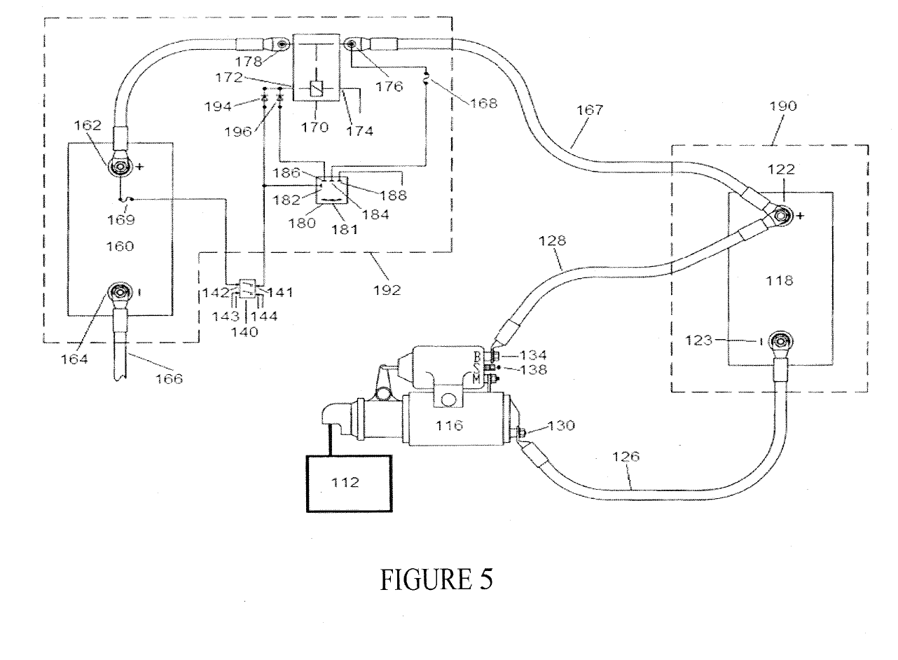

FIGS. 4-6 further illustrate the operation of the alternative vehicle electrical system. FIG. 4 shows the multi-pole switch 140 in its off positions, and relay 170 in their respective open-circuit states. FIG. 5 shows the multi-pole switch 140 switched into the start state which causes capacitor 160 to deliver a voltage between the control terminals 172, 174, thus closing the relay 170 and completing the electrical path 167. Thus the capacitor 160 and the batteries 118 are each connected along electrical paths to the cranking motor 116. The batteries 118 power the cranking motor 116 during ignition. The capacitor 160 also delivers a voltage between the start switched terminal 182 and the power and/or load switched terminals 184, 186, which causes MCC 180 to transition from an idle state to the start-up state. In alternative implementations a secondary capacitor, secondary battery, or alternative power source can deliver the voltage between the start switched terminal 182 and the power and/or load switched terminals 184, 186 rather than capacitor 16. The rear multi-pole switch (not shown) is used in some implementations instead of multi-pole switch 140.

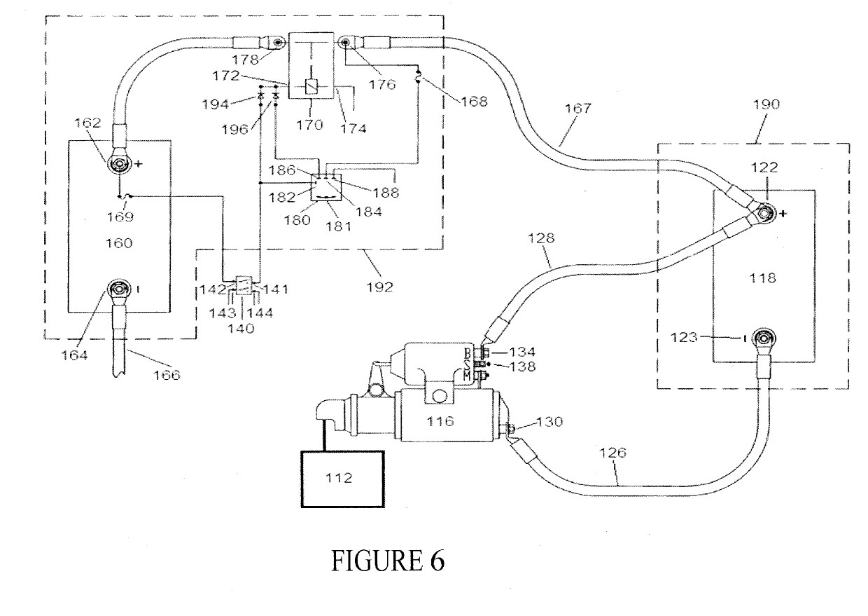

FIG. 6 shows the multi-pole switch 140 switched into the on/run state, which opens the electrical paths between switched terminals 141 and 142 and between switched terminals 143 and 144. Thus the capacitor 160 no longer delivers a voltage between the start switched terminal 182 and the power and/or load switched terminals 184, 186, causing MCC 180 to transition to a charging state. In this state MCC 180 operates like MCC 80 described above. When charging capacitor 160, a closed electrical path is formed between the power and load switched terminals 184, 186, causing the capacitor 160 to continue to deliver a voltage between the control terminals 172 and 174 thus keeping the relay 170 closed and the electrical path 167 closed. Thus a part of the vehicle electrical system, for example the generator or alternator, charges the capacitor 160 during the charging state. The programmed time used to recharge capacitor 160 will vary with the condition and state of the capacitor 160 and the voltage and current delivered by the generator or alternator.

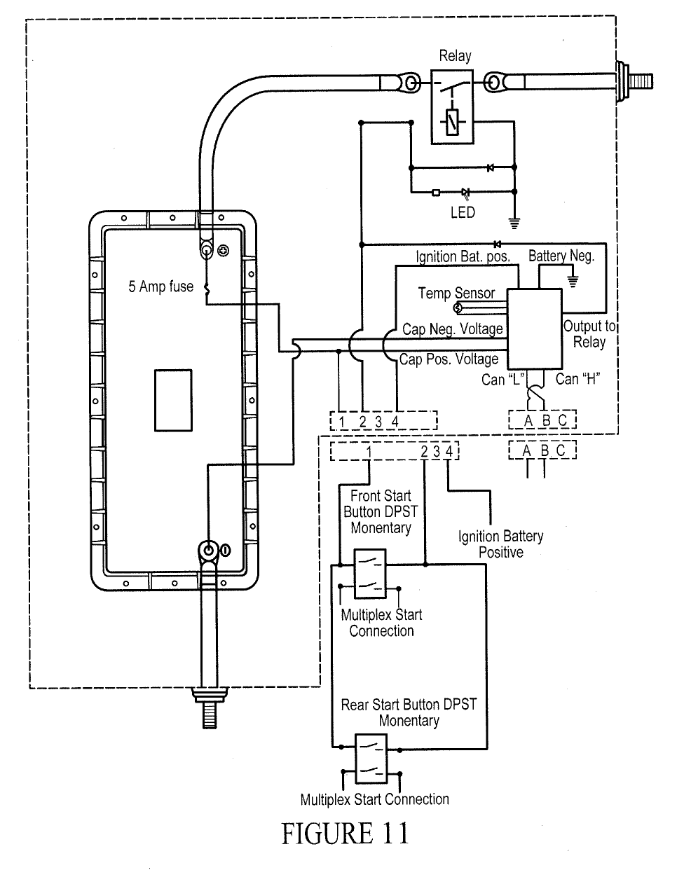

Once the charge cycle is completed, the electrical path between the second and third switched terminals 184, 186 opens, and MCC 180 switches to an idle state waiting for a vehicle bus request. The electrical circuit thus returns to the condition shown in FIG. 4. Once recharged, capacitor 160 is electrically isolated from the vehicle. The vehicle continues to run, based on power provided from batteries 118 or from the vehicle electrical system until the multi-pole switch 140 transitions from an on/run state to the off state. And, FIG. 11 shows the MCC 180 implemented in the programmable logic controller (PLC) or microprocessor based charge controller of the vehicle starting system. Some systems include a bi-color led such as a red/green LED, one side of the LED, such as the green side is connected terminal block as shown in FIG. 11, the other side, such as the red side is connected to an output of the PLC. The PLC monitors the capacitor's (160) voltage before, during, and/or after the recharge cycle. If the capacitor voltage drops below a predetermined level in a programmable period, such as within a 5 minute period after a recharge level is attained, for example, the red LED will flash at a predetermined frequency such as a 1 Hz rate indicating that a fault was detected by MCC 180. If at any time while PLC is powered up an internal fuse blows or the capacitor voltage level drops below a predetermined level, such as about 4 volts, for example, the red LED will flash at a 1 hz rate or at a different frequency rate. In some systems each frequency rate and/or color is selected based on the error condition MCC 180 detects. In some systems MCC 180 monitor capacitor (160) current that identifies performance failures or likelihoods of impending failures. Once detected, the system renders a trouble code that identifies the error condition and in some systems its severity or expected severity. The severity may be identified by the level of luminescence, flash frequency, color, or by code, for example.

In the supplemental electrical systems of FIGS. 4-6, diode 194 prevents the relay 170 from providing power to the start switched terminal 182 of MCC 180 while the ignition 140 is in the on/run state, as in FIG. 6. The start switched terminal 182 is configured to receive current only while the ignition 140 is in the start state, as in FIG. 5.

The methods, devices, systems, and logic described above may be implemented in many different ways and have many different uses. For example, the microprocessor based vehicle starting module may be activated for the purposes of battery correction even when the vehicle's recharging system is operational. For example, to compensate for additional electrical loads such as loads caused by variations in air conditioning operation or fuel injector operation that causes variations in battery voltage. In operation, when a significant load is placed on the vehicle's electrical system, the powertrain module, electronic control module and/or electronic control unit may communicate with the microprocessor based charge controllers (MCC 80 or MCC 180) bringing capacitor (60 or 160) on-line to deliver the additional power needed to drive the additional load. When engaged, the powertrain module, electronic control module and/or electronic control unit may engage the microprocessor based charge controllers by transmitting a request via the vehicle bus.

The methods, devices, systems, and logic described above may also be implemented in many different ways in many different combinations of hardware, software or both hardware and software. When implemented in software a memory device such as a read only memory device may be used that includes one or more data storage areas and one or more programs. The data and programs are accessible to the computer processor so that the computer processor is particularly programmed to implement the starting, charging, recharging, and communication functionality of the system. The programs may include one or more modules executable by the computer processor to perform the desired function disclosed. For example, the program modules may include a charge controller module, a temperature calculation or estimation module; a maximum capacitor charging module, and a timing module that execute the functionality disclosed herein. In some implementations, the modules correspond to the process step or steps described with respect to FIG. 7. The memory device may also store additional programs, modules, or other data to provide additional programming that allow the computer processor to perform the functionality of the vehicle power starting system. The described modules and programs may be parts of a single program, separate programs, or distributed across several memories and processors. Furthermore, the programs and modules, or any portion of the programs and modules, may instead be implemented in hardware.

For example, all or parts of the microprocessor based controller may comprise one or more microprocessors (CPUs), one or more signal processors (SPU), one or more application specific integrated circuit (ASIC), one or more programmable media or any and all combinations of such hardware. All or part of the logic, specialized processes, and systems described may be implemented as instructions for execution by multi-core processors (e.g., CPUs, and/or SPUs,), controller, or other processing device and may communicate with users via a display driver in communication with a remote or local display. The processes described may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The term “coupled” used in this description encompasses both direct and indirect connections. Thus, first and second parts are said to be coupled together when they have direct continuity with one another, as well as when the first part couples an intermediate part which couples either directly or via one or more additional intermediate parts the second part. The term “battery” encompasses one or more batteries. The term “set” means one or more. The term “path” includes one or more elements that provide electrical interconnections through cables or other electrical mediums. A path may include one or more switches or circuit elements in series with one or more conductors. The term “substantially” or “about” may encompass a range that is largely, but not necessarily wholly, that which is specified. It encompasses all but a significant amount. When devices are responsive to outputs generated by other devices, the outputs necessarily occur as a direct or indirect result of the preceding events and/or actions. In other words, the operations occur as a result of the preceding operations. A device that is responsive to another requires more than an action (i.e., the device's response to) merely follow another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A vehicle power starting method comprising:
generating a recharging function by a computer processor based on a temperature and a voltage of a vehicle starting capacitor;
obtaining a temperature of the vehicle starting capacitor when running in parallel with a motorized vehicle's battery and the motorized vehicle's electrical system;
calculating a maximum charging level by the computer processor of the vehicle starting capacitor running in parallel with a motorized vehicle's battery and the motorized vehicle's electrical system; and
adapting the recharging process of the vehicle starting capacitor by the computer processor based on the recharging function and a predetermined charging cycle time period.

2. The method of claim 1 where the recharging function comprises a linear function of temperature versus an analog voltage.

3. The method of claim 1 where the recharging function comprises a non-linear function of temperature versus a digital voltage.

4. The method of claim 1 where obtaining the temperature of the capacitor comprises obtaining a temperature of a surrogate area in proximity to the vehicle starting capacitor.

5. The method of claim 4 where the temperature is measured at a resolution greater than one hundred degrees.

6. The method of claim 1 further comprising:
coupling the vehicle starting capacitor in parallel with the motorized vehicle's battery and the vehicle's electrical system; and
cranking the vehicle's engine before obtaining a temperature of the vehicle starting capacitor and calculating a maximum charging level of the vehicle starting capacitor by the computer processor.

7. The method of claim 6 further comprising:
uncoupling the vehicle starting capacitor from the motorized vehicle's battery and the vehicle's electrical system when the vehicle's starting capacitor is substantially recharged.

8. The method of claim 1 where adapting the charging process comprises:
coupling the vehicle starting capacitor to the vehicle's battery and electrical system;
monitoring the vehicle starting capacitor voltage level for a predetermined period of time;
uncoupling the vehicle starting capacitor to the vehicle's battery and electrical system for a second predetermined period of time; and then
determining if the voltage of the vehicle starting capacitor is charged to substantially the recharge voltage determined by the recharging function.

9. The method of claim 1 where the computer processor automatically detects and communicates with the vehicle's computer bus.

10. The method of claim 1 where the computer processor is programmed to:
automatically monitor the state of the vehicle starting capacitor;
generate a malfunction code when the computer detects a fault in vehicle starting capacitor; and
automatically communicate with the vehicle's computer bus when a fault is detected;
where the vehicle starting capacitor is physically separate but electrically coupled to the vehicles electrical system.

11. The method of claim 10 where the computer processor is programmed to communicate with the vehicle's powertrain controller and turn on a check engine light within the vehicle cluster when the fault is detected.

12. A vehicle starting system, comprising:
a computer processor;
a maximum capacitor charging module executable by the computer processor to generate a recharging function based on a temperature and a voltage of a vehicle starting capacitor;
a temperature estimation module executable by the computer processor to estimate the operating temperature of the vehicle starting capacitor; and
a charge control module executable by the computer processor to calculate a maximum charging level of the vehicle starting capacitor when the vehicle starting capacitor is running in parallel with a motorized vehicle's battery and the motorized vehicle's electrical system.

13. The system of claim 12 further comprising a timing module executable by the computer processor to determine and track the recharging cycle of the vehicle starting capacitor.

14. The system of claim 13 where the charge control module adapts the recharging process of the vehicle starting capacitor based on the recharging function and a predetermined charging cycle time period tracked by the timing module.

15. The system of claim 12 where the recharging function comprises a linear function of temperature versus an analog voltage.

16. The system of claim 12 where the recharging function comprises a non-linear function of temperature versus a digital voltage.

17. The system of claim 12 where temperature estimation module estimate the operating temperature of the vehicle starting capacitor by estimating a temperature of a surrogate area in proximity to the vehicle starting capacitor.

18. The system of claim 12 where the computer processor automatically detects and communicates with the vehicle's computer bus.

19. The system of claim 12 where the charge control module:
automatically monitor the state of the vehicle starting capacitor;
generates a malfunction code when the computer detects a fault in the vehicle starting capacitor; and
automatically communicate with the vehicle's computer bus when a fault is detected.

20. The system of claim 13 where the charge control module communicates with the vehicle's powertrain controller which turns on the check engine light when the fault is detected.
